(19) United States
(12) Patent Application Publication
(10) Pub. No.: US 2021/0090003 A1
(43) Pub. Date: Mar. 25, 2021

(54) SYSTEMS AND METHODS FOR OUTBOUND FORECASTING BASED ON POSTAL CODE MAPPING

(71) Applicant: Coupang, Corp., Seoul (KR)

(72) Inventors: Ke MA, Shanghai (CN); Christopher CARLSON, Seoul (KR); Shixian LI, Shanghai (CN); Nan WANG, Shanghai (CN); Bin GU, Shanghai (CN)

(73) Assignee: Coupang, Corp., Seoul (KR)

(21) Appl. No.: 16/576,272

(22) Filed: Sep. 19, 2019

(51) Int. Cl. G06Q 10/08; G06Q 10/04; G06N 5/00

(52) U.S. Cl. CPC G06Q 10/083; G06N 5/003; G06Q 10/04

(57) ABSTRACT

The embodiments of the present disclosure provide systems and methods for outbound forecasting, comprising receiving an initial distribution of postal codes mapped to each region, running a simulation of the initial distribution, calculating an outbound capacity utilization value of each FC, determining a number of FCs comprising an outbound capacity utilization value that exceeds a predetermined threshold, feeding an optimization heuristic with at least one of the postal codes mapped to a region from the initial distribution to generate one or more additional distributions of postal codes, generating an optimal distribution of postal codes mapped to each region based on the one or more additional distributions of postal codes, and modify an allocation of customer orders among a plurality of FCs based on the generated optimal distribution of postal codes. Running the simulation may comprise simulating an allocation of customer orders based on the initial distribution of postal codes.

### TECHNICAL FIELD

The present disclosure generally relates to computerized systems and methods for outbound forecasting. In particular, embodiments of the present disclosure relate to inventive and unconventional systems related to outbound forecasting based on an optimal distribution of postal codes mapped to each region using a simulation model.

### BACKGROUND

Typically, when customer orders are made, the orders must be transferred to one or more fulfillment centers. However, customer orders, especially online customer orders, are made by many different customers located at many different regions, and as such, the orders are bound for many different destinations. Therefore, the orders must be properly sorted such that they are routed to an appropriate fulfillment center and, ultimately, correctly routed to their destination.

Systems and methods for optimizing shipping practices and identifying shipping routes for outbound products already exist. For example, conventional methods simulate shipments according to shipping routes. In order to determine the optimal routing plan, an alternative routing module can modify package routing data according to a user input. That is, the user may manually change data associated with the original package routing data and view the effects of each routing change. This process is repeated until the optimal routing plan is determined.

However, these conventional systems and methods for outbound forecasting of products is difficult, time-consuming, and inaccurate mainly because they require manual modification and repeated testing of individual combinations of parameters. Especially for entities with multiple fulfillment centers throughout the region and multiple regions throughout the network, it is significantly challenging and time-consuming to replicate outbound flow of products at all levels of processes, including the level at which customer orders are initially received, the level at which inbound/stowing/inventory estimates are determined, and the level at which logic to assign orders to various fulfillment centers is determined. In addition, because conventional systems and methods require manual modification and repeated testing after each modification, simulation can only be done on a larger scale, rather than on a granular scale. For example, simulation cannot be done on a customer order level, where each customer order in each region is used by the simulation model for outbound forecasting.

In addition, conventional systems and methods for forecasting outbound flow of products do not allow for efficient mapping of postal codes to each region. That is, conventional systems and methods cannot vary each region based on customer orders associated with each postal code. Accordingly, because the regions are predetermined and fixed, conventional systems and methods cannot account for unexpected increase in customer demand for a particular product in a particular region, which could significantly affect future outbound flow of products.

Therefore, there is a need for improved systems and methods for outbound forecasting of products. In particular, there is a need for improved systems and methods for outbound forecasting based on an optimal distribution of postal codes mapped to each region, which may optimize outbound capacity utilization of FCs in a network. In addition, there is a need for improved systems and methods for outbound forecasting that is capable of adaptively changing the postal codes mapped to each region, using a simulation model, based on past and/or pending customer orders.

### SUMMARY

One aspect of the present disclosure is directed to a computer-implemented system for outbound forecasting. The system may comprise a memory storing instructions and at least one processor configured to execute the instructions. The at least one processor may be configured to execute the instructions to receive an initial distribution of postal codes mapped to each region, run a simulation, using a simulation model, of the initial distribution, calculate an outbound capacity utilization value of each fulfillment center (FC) in each region, determine a number of FCs comprising an outbound capacity utilization value that exceeds a predetermined threshold, feed an optimization heuristic with at least one of the postal codes mapped to a region from the initial distribution to generate one or more additional distributions of postal codes, until the number of FCs comprising the outbound capacity utilization value that exceeds the predetermined threshold exceeds a second predetermined threshold, generate, using the optimization heuristic, an optimal distribution of postal codes mapped to each region based on the one or more additional distributions of postal codes, and modify an allocation of customer orders among a plurality of FCs based on the generated optimal distribution of postal codes. Running the simulation may comprise simulating an allocation of customer orders based on the initial distribution of postal codes.

In some embodiments, the predetermined threshold may comprise a minimum outbound of each FC. In some embodiments, the outbound capacity utilization value of each FC may comprise a ratio of an outbound of each FC to an outbound capacity of each FC. The optimization heuristic may comprise a genetic algorithm. In some embodiments, the initial distribution of postal codes mapped to each region may be randomly generated.

In some embodiments, the at least one processor may be further configured to execute the instructions to cache at least a portion of the optimization heuristic. The cached portion of the optimization heuristic may comprise at least one constraint that remains substantially constant with each run of the simulation model. In some embodiments, the at least one processor may be further configured to execute the instructions to determine one or more constraints associated with at least one of the postal codes and apply the one or more constraints to the optimization heuristic to generate the one or more additional distributions of postal codes. In some embodiments, applying the one or more constraints to the optimization heuristic may comprise eliminating at least one of the one or more additional distributions of postal codes that ignore the one or more constraints. In some embodiments, the optimization heuristic may comprise at least one constraint, the constraint comprising at least one of customer demand at each of the FCs, maximum capacities of the FCs, compatibility with FCs, or transfer costs between FCs.

Another aspect of the present disclosure is directed to a computer-implemented method for outbound forecasting. The method may comprise receiving an initial distribution of postal codes mapped to each region, running a simulation, using a simulation model, of the initial distribution, calculating an outbound capacity utilization value of each fulfillment center (FC) in each region, determining a number of FCs comprising an outbound capacity utilization value that exceeds a predetermined threshold, feeding an optimization heuristic with at least one of the postal codes mapped to a region from the initial distribution to generate one or more additional distributions of postal codes, until the number of FCs comprising the outbound capacity utilization value that exceeds the predetermined threshold exceeds a second predetermined threshold, generating, using the optimization heuristic, an optimal distribution of postal codes mapped to each region based on the one or more additional distributions of postal codes, and modifying an allocation of customer orders among a plurality of FCs based on the generated optimal distribution of postal codes. Running the simulation may comprise simulating an allocation of customer orders based on the initial distribution of postal codes.

In some embodiments, the predetermined threshold may comprise a minimum outbound of each FC. In some embodiments, the outbound capacity utilization value of each FC may comprise a ratio of an outbound of each FC to an outbound capacity of each FC. The optimization heuristic may comprise a genetic algorithm. In some embodiments, the initial distribution of postal codes mapped to each region may be randomly generated.

In some embodiments, the method may further comprise caching at least a portion of the optimization heuristic. The cached portion of the optimization heuristic may comprise at least one constraint that remains substantially constant with each run of the simulation model. In some embodiments, the method may further comprise determining one or more constraints associated with at least one of the postal codes and applying the one or more constraints to the optimization heuristic to generate the one or more additional distributions of postal codes. In some embodiments, applying the one or more constraints to the optimization heuristic may comprise eliminating at least one of the one or more additional distributions of postal codes that ignore the one or more constraints.

Yet another aspect of the present disclosure is directed to a computer-implemented system for outbound forecasting. The system may comprise a memory storing instructions and at least one processor configured to execute the instructions. The at least one processor may be configured to execute the instructions to receive an initial distribution of postal codes mapped to each region, run a simulation, using a genetic algorithm, of the initial distribution, calculate an outbound capacity utilization value of each fulfillment center (FC), determine a number of FCs comprising an outbound capacity utilization value that exceeds a predetermined threshold, determine one or more constraints associated with at least one of the postal codes, feed a genetic algorithm with at least one of the postal codes mapped to a region from the initial distribution to generate one or more additional distributions of postal codes, until the number of FCs comprising the outbound capacity utilization value that exceeds the predetermined threshold exceeds a second predetermined threshold, generate, using the genetic algorithm, an optimal distribution of postal codes mapped to each region based on the one or more additional distributions of postal codes, and modify an allocation of customer orders among a plurality of FCs based on the generated optimal distribution of postal codes. The initial distribution of postal codes may be randomly generated. In addition, one or more constraints may be applied to the genetic algorithm to generate the one or more additional distributions of postal codes. Running the simulation may comprise simulating an allocation of customer orders based on the initial distribution of postal codes.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a schematic block diagram illustrating an exemplary embodiment of a system comprising an outbound forecasting system, consistent with the disclosed embodiments.

FIG. 4 is an exemplary distribution of postal codes mapped to each region, consistent with the disclosed embodiments.

FIG. 5 is a flowchart illustrating an exemplary embodiment of a method for outbound forecasting, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for outbound forecasting based on an optimal distribution of postal codes mapped to each region using a simulation model.

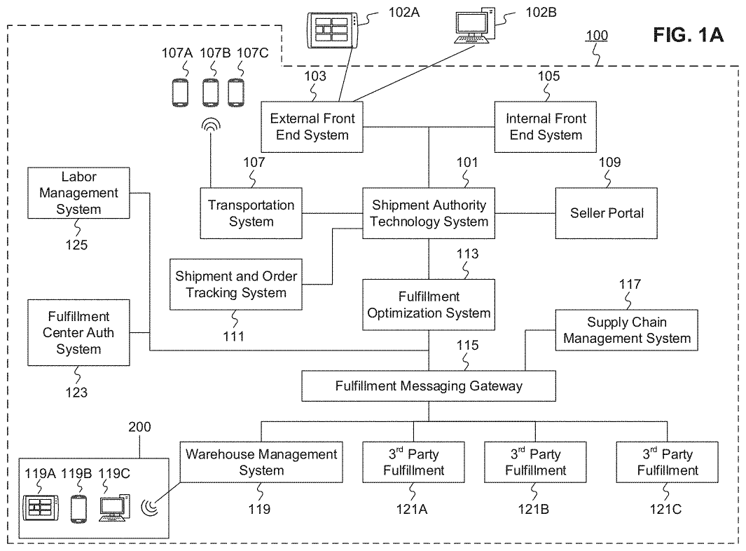

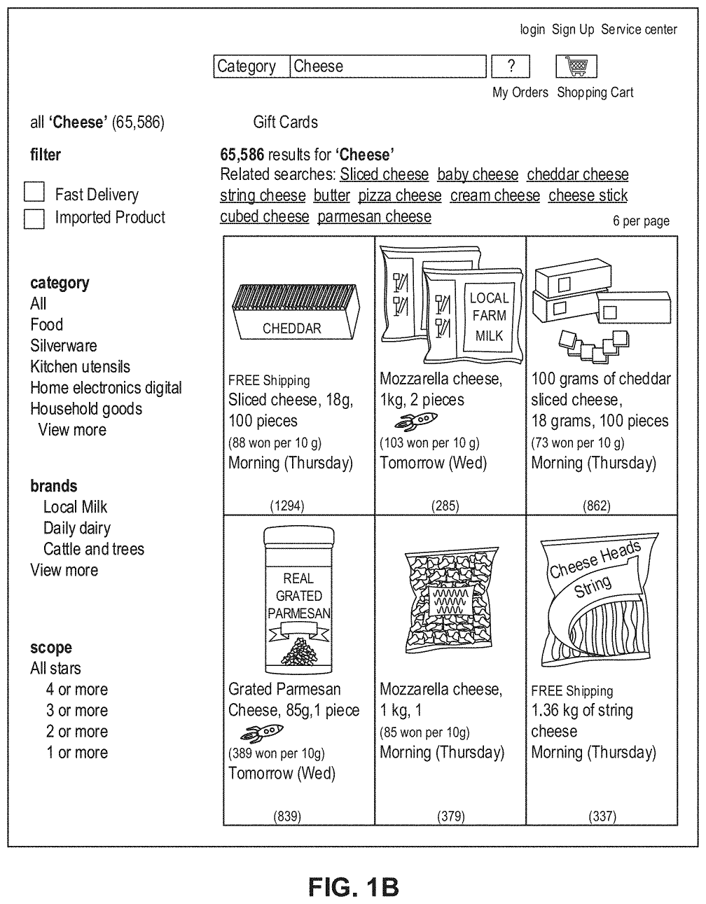

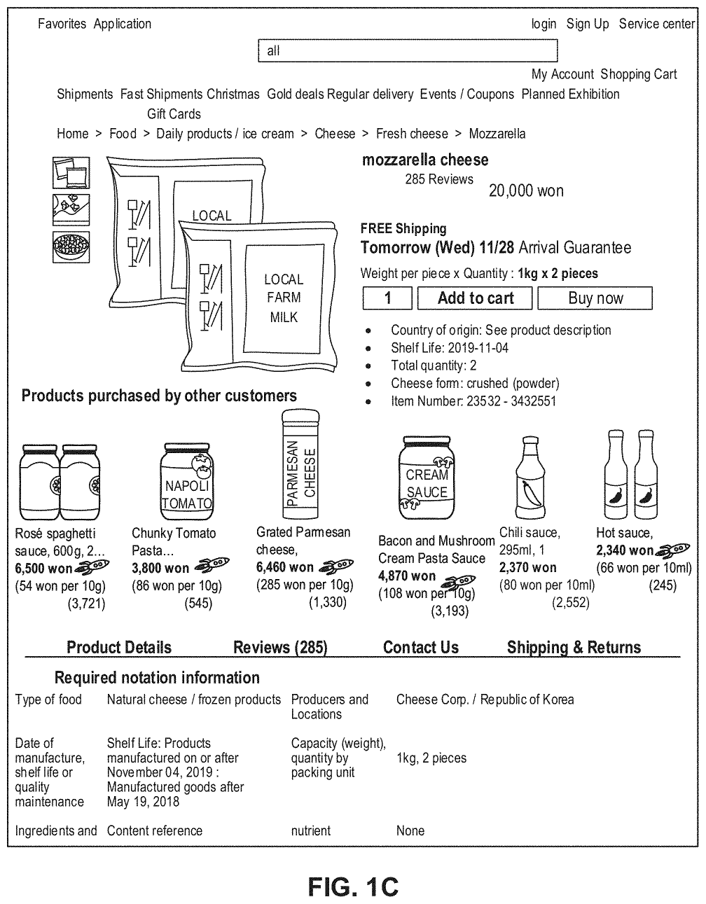

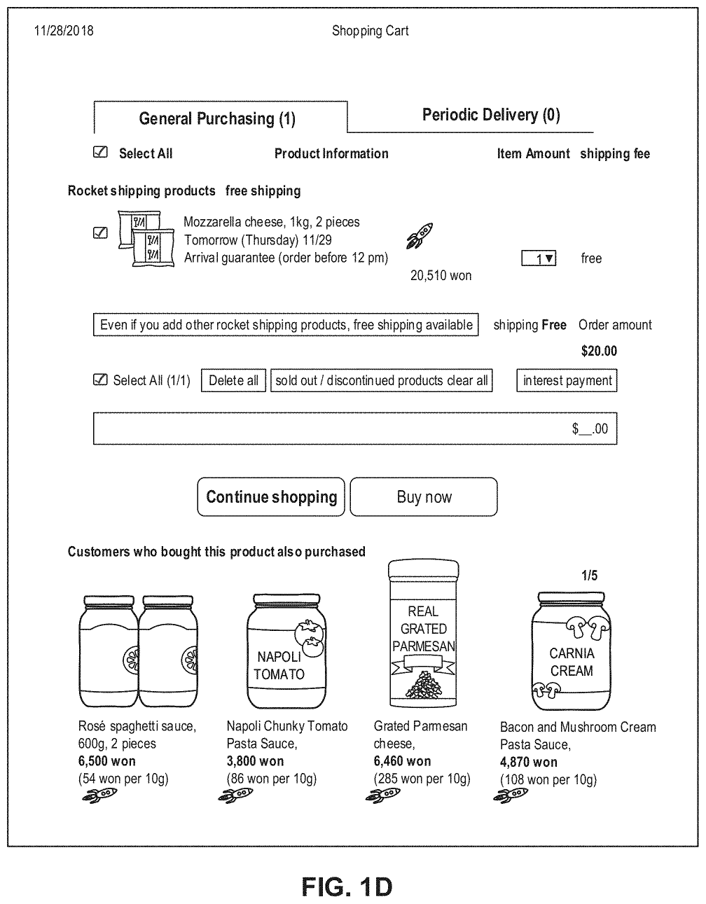

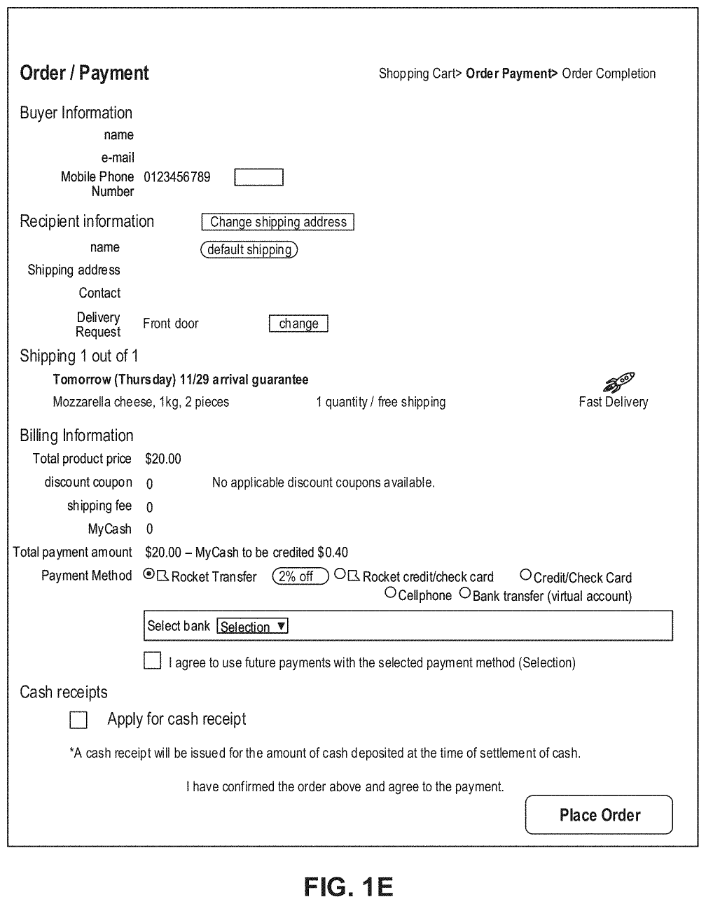

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3rd party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field , a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3rd party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

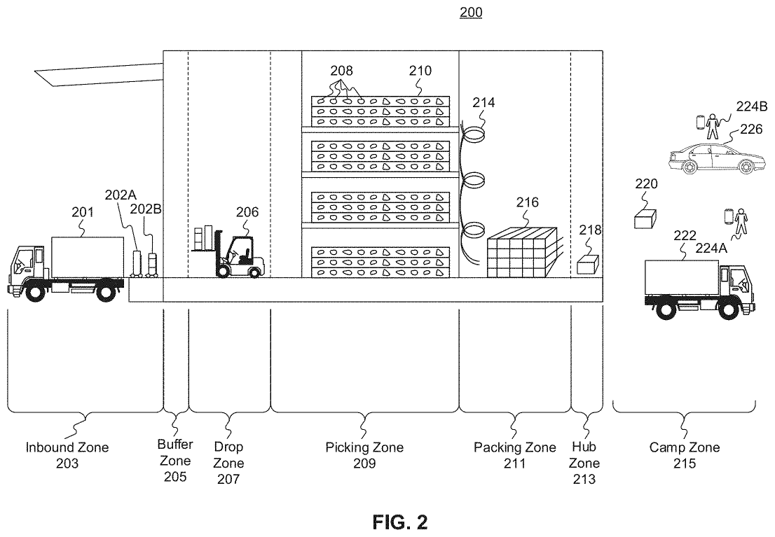

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 1196 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

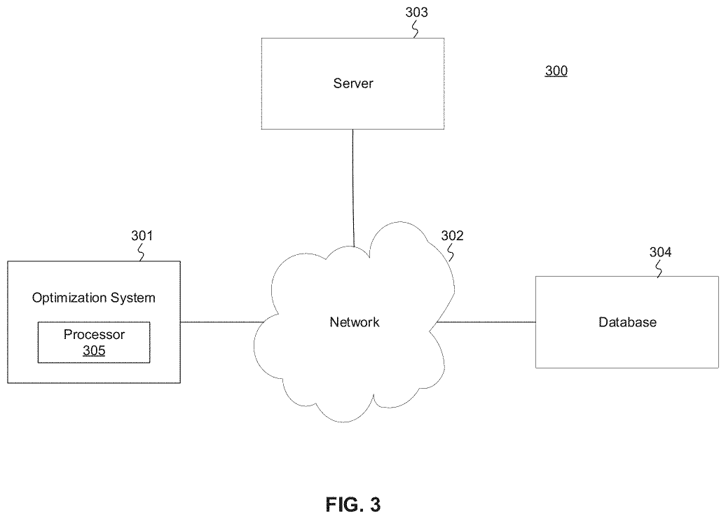

Referring to FIG. 3, a schematic block diagram 300 illustrating an exemplary embodiment of a system comprising an outbound forecasting system 301. Outbound forecasting system 301 may be associated with one or more systems in system 100 of FIG. 1A. For example, outbound forecasting system 301 may be implemented as part of SCM system 117. Outbound forecasting system 301, in some embodiments, may be implemented as a computer system that processes information for each FC 200 as well as information for customer orders from other systems (e.g., external front end system 103, shipment and order tracking system 111, and/or FO system 113). For example, outbound forecasting system 301 may include one or more processors 305, which may process information describing a distribution of SKUs among FCs and store the information in a database, such as database 304. One or more processors 305 of outbound forecasting system 301, thus, may process a list of SKUs that are stored in each FC and store the list in database 304. Additionally or alternatively, one or more processors 305 may process information associated with each region, such as postal codes mapped to each region. By way of example, a first region may be mapped to a first plurality of postal codes and may comprise a first plurality of FCs in an area associated with the first plurality of postal codes. A second region may be mapped to a second plurality of postal codes and may comprise a second plurality of FCs in an area associated with the second plurality of postal codes. Therefore, one or more products that are stowed in the first plurality of FCs may be routed to one or more of the first plurality of postal codes in the first region, and one or more products that are stowed in the second plurality of FCs may be routed to one or more of the second plurality of postal codes in the second region. One or more processors 305 may process this type of information associated with each region and store this information in database 304.

One or more processors 305 may also process information describing constraints associated with each of the FCs and store the information in database 304. For example, certain FCs may have constraints, including maximum capacity, compatibility with certain items due to size, refrigeration needs, weight, or other item requirements, costs of transfer, building restrictions, and/or any combination thereof. By way of example, certain items may be stored only in one fulfillment center, while certain other items may be stored in multiple fulfillment centers. In still other embodiments, certain fulfilment centers may be designed to store only a particular set of items (e.g., fresh produce or frozen products). One or more processors 305 may process or retrieve this information as well as associated information (e.g., quantity, size, date of receipt, expiration date, etc.) for each FC and store this information in database 304.

In some embodiments, one or more processors 305 of the outbound forecasting system 301 may also be configured to generate an optimal distribution of postal codes mapped to each region. By way of example, one or more processors 305 may be configured to receive an initial distribution of postal codes mapped to each region. The initial distribution of postal codes may be randomly generated. One or more processors 305 may run a simulation, using a simulation model, of the initial distribution and calculate an outbound capacity utilization (OCU) value of each FC. In some embodiments, one outbound capacity utilization value may be calculated for a network of FCs. One or more processors 305 may determine a number of FCs comprising an outbound capacity utilization value that exceeds a predetermined threshold and feed an optimization heuristic, such as a genetic algorithm, with at least one of the determined number of FCs to generate one or more additional distributions of postal codes. One or more processors 305 may then generate, using the optimization heuristic, an optimal distribution of postal codes mapped to each region based on the one or more additional distributions of postal codes. In some embodiments, one or more processors 305 may also modify an allocation of customer orders among a plurality of FCs based on the generated optimal distribution of postal codes. Accordingly, the simulation model may be used to simulate outbound process and evaluate the effect of different distributions of postal code on the overall outbound of the FC network. Based on the simulation provided by the simulation model, data may be obtained to calculate an outbound capacity utilization value. The optimization heuristic, such as a genetic algorithm, may be used to optimize the outbound capacity utilization value. For example, one or more processors 305 may use the optimization heuristic to obtain the optimal outbound capacity utilization value and an optimal distribution of postal codes to FCs that will provide the optimal outbound capacity utilization value. As discussed above, one or more processors 305 may use an optimization heuristic, such as a genetic algorithm, to obtain the optimal outbound capacity utilization value and an optimal distribution of postal codes. By way of example, one or more processors 305 may randomly select two postal codes, from the initial distribution of postal codes and exchange the two postal codes such that the postal codes mapped to respective FCs are switched with each other. Then, one or more processors 305 may run a simulation, using the simulation model, of the new distribution of postal codes so as to calculate the outbound capacity utilization value of the new distribution of postal codes. Additionally or alternatively, one or more processors 305 may randomly select one or more postal codes from the initial distribution of postal codes and randomly assign a new value (e.g., a new postal codes). Then, one or more processors 305 may run a simulation, using the simulation model, of the new distribution of postal codes so as to calculate the outbound capacity utilization value of the new distribution of postal codes. One or more processors 305 may repeat these steps, using the optimization heuristic and the simulation model, to obtain the optimal outbound capacity utilization value and an optimal distribution of postal codes to FCs that will provide the optimal outbound capacity utilization value.

In other embodiments, one or more processors 305 may store forecasted outbound of customer orders and/or products associated with corresponding SKUs to FCs 200 in a database 304. In some embodiments, outbound forecasting system 301 may retrieve information from the database 304 over network 302. Database 304 may include one or more memory devices that store information and are accessed through network 302. By way of example, database 304 may include Oracle™ databases, Sybase™ databases, or other relational databases or non-relational databases, such as Hadoop sequence files, HBase, or Cassandra. While database 304 is illustrated as being included in the system 300, it may alternatively be located remotely from system 300. In other embodiments, database 304 may be incorporated into optimization system 301. Database 304 may include computing components (e.g., database management system, database server, etc.) configured to receive and process requests for data stored in memory devices of database 304 and to provide data from database 304.

System 300 may also comprise a network 302 and a server 303. outbound forecasting system 301, server 303, and database 304 may be connected and be able to communicate with each other via network 302. Network 302 may be one or more of a wireless network, a wired network or any combination of wireless network and wired network. For example, network 302 may include one or more of a fiber optic network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving data.

In addition, network 302 may include, but not be limited to, telephone lines, fiber optics, IEEE Ethernet 902.3, a wide area network (“WAN”), a local area network (“LAN”), or a global network such as the Internet. Also network 302 may support an Internet network, a wireless communication network, a cellular network, or the like, or any combination thereof. Network 302 may further include one network, or any number of the exemplary types of networks mentioned above, operating as a stand-alone network or in cooperation with each other. Network 302 may utilize one or more protocols of one or more network elements to which they are communicatively coupled. Network 302 may translate to or from other protocols to one or more protocols of network devices. Although network 302 is depicted as a single network, it should be appreciated that according to one or more embodiments, network 302 may comprise a plurality of interconnected networks, such as, for example, the Internet, a service provider's network, a cable television network, corporate networks, and home networks.

Server 303 may be a web server. Server 303, for example, may include hardware (e.g., one or more computers) and/or software (e.g., one or more applications) that deliver web content that can be accessed by, for example a user through a network (e.g., network 302), such as the Internet. Server 303 may use, for example, a hypertext transfer protocol (HTTP or sHTTP) to communicate with a user. The web pages delivered to the user may include, for example, HTML documents, which may include images, style sheets, and scripts in addition to text content.

A user program such as, for example, a web browser, web crawler, or native mobile application, may initiate communication by making a request for a specific resource using HTTP and server 303 may respond with the content of that resource or an error message if unable to do so. Server 303 also may enable or facilitate receiving content from the user so the user may be able to, for example, submit web forms, including uploading of files. Server 303 may also support server-side scripting using, for example, Active Server Pages (ASP), PHP, or other scripting languages. Accordingly, the behavior of server 303 can be scripted in separate files, while the actual server software remains unchanged.

In other embodiments, server 303 may be an application server, which may include hardware and/or software that is dedicated to the efficient execution of procedures (e.g., programs, routines, scripts) for supporting its applied applications. Server 303 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Server 303 may act as a set of components accessible to, for example, an entity implementing system 100, through an API defined by the platform itself.

In another embodiment, one or more processors 305 may be able to implement one or more constraints, such as business constraints, to the optimization heuristic, such as a genetic algorithm. Constraints may include, for example, maximum capacity of each FC, item compatibility associated with each FC, costs associated with FC, or any other characteristics associated with each FC. Maximum capacity of each FC may include information associated with how many SKUs can be held at each FC. Item compatibility associated with each FC may include information associated with certain items that cannot be held at certain FCs due to size of the items, weight of the items, need for refrigeration, or other requirements associated with the items/SKUs. There may also be building restrictions associated with each FC that allow certain items to be held and prevent certain items to be held at each FC. Costs associated with each FC may include FC-to-FC transfer costs, cross-cluster shipment costs (e.g., shipping costs incurred from shipping items from multiple FCs), shipping costs incurred from cross-stocking items between FCs, unit per parcel (UPP) costs associated with having all SKUs in one FC, or any combination thereof.

In other embodiments, one or more processors 305 may cache one or more portions of the optimization heuristic, such as a genetic algorithm, in order to increase efficiency. For example, one or more portions of the optimization heuristic may be cached to obviate the need to re-run all portions of the algorithm each time a simulation is generated. One or more processors 305 may determine which portion(s) of the optimization heuristic may be cached based on whether there will be significant changes in each iteration. For example, some parameters may remain consistent each time a simulation is generated, while other parameters may change. Accordingly, one or more processors 305 may cache a portion of the optimization heuristic that will remain substantially constant with each iteration of the simulation model. The parameters that remain consistent each time will not need to be re-run each time a simulation is generated. Therefore, one or more processors 305 may cache these consistent parameters. For example, maximum capacity at each FC may not change each time a simulation is generated, and thus, may be cached. On the other hand, parameters that may vary per simulation may include, for example, customer order profiles, customer interest in each SKU across regions, or stowing models. Customer order profiles may refer to behavior of customer orders across a statewide, regional, or nationwide network. For example, customer order profiles may refer to ordering patterns of customer orders across a statewide, regional, or nationwide network. Customer interest in each SKU may refer to the amount of customer demand for each item across a statewide, regional, or nationwide network. Stowing models may refer to models indicating where a particular item is placed, such as a particular spot in picking zone 209 or a particular space on a storage unit 210 in each FC. Stowing models may vary for each FC. By caching one or more portions of the optimization heuristic, one or more processors 305 may increase efficiency and reduce processing capacity.

In some embodiments, another constraint added to the optimization heuristic may comprise customer demand at each of the FCs. One or more processors 305 may be able to determine customer demand at each of the FCs by looking at order histories at each of the FCs. In other embodiments, one or more processors 305 may simulate customer demand at each of the FCs. For example, based on at least the order histories at each FC, one or more processors 305 may predict and/or simulate customer demand at each FC. Based on at least the simulated customer demand at each of the FCs, one or more processors 305 may modify an allocation of SKUs among the FCs in order to optimize SKU allocation, SKU mapping, and outbound flow of products.

In some embodiments, one or more postal codes mapped to the regions in the network may also comprise one or more constraints. Accordingly, one or more processors 305 may determine one or more constraints associated with one or more postal codes and apply the constraint(s) to the optimization heuristic to generate one or more additional distributions of postal codes. For example, a particular postal code may only be mapped to a particular region because the particular postal code may only be accessed through the particular region, by way of example. As such, a constraint may be placed on the optimization heuristic such that the particular postal code is always mapped to the particular region. In some embodiments, for example, applying the one or more constraints to the optimization heuristic may comprise eliminating at least one of the one or more additional distributions of postal codes that ignore the one or more constraints. For example, while generating one or more additional distributions of postal codes mapped to each region by each iteration of the simulation model, if there are distributions, in which the particular postal code discussed above is mapped to a region other than the particular region, those distributions would be ignoring the constraint. As such, the distributions that ignore the constraint associated with the particular postal code may be eliminated, such that those distributions may not be incorporated into the optimal distribution of postal codes that may be ultimately used to modify the allocation of customer orders among FCs.

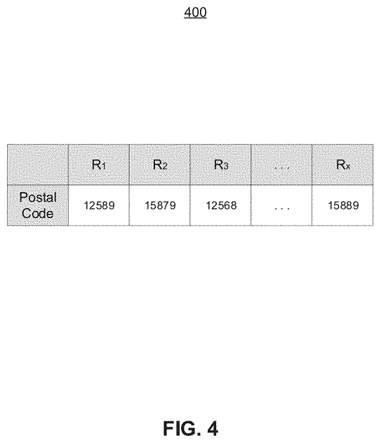

FIG. 4 is an exemplary distribution 400 of postal codes mapped to each region (Rx), consistent with the embodiments of the present disclosure. Referring to distribution 400 of FIG. 4, for example, region R₁ may be mapped to postal code “12589,” region R₂ may be mapped to postal code “15879,” region R₃ may be mapped to postal code “12568,” and so forth.

As discussed above, an initial distribution 400 may be randomly generated. That is, the postal codes mapped to each region (Rₓ) may be randomly generated. One or more processors 305 may be configured to run a simulation of the initial distribution 400 using a simulation model. As such, one or more processors 305 may simulate outbound flow when each region is mapped to the postal codes in distribution 400. For example, one or more processors 305 may calculate an outbound capacity utilization value of each FC in each region after running the simulation of distribution 400 of postal codes. The outbound capacity utilization value may comprise a ratio of an outbound of each FC to an outbound capacity of the FC. Then, one or more processors 305 may determine a number of FCs comprising an outbound capacity utilization value that exceeds a predetermined threshold. The predetermined threshold may comprise a minimum outbound of each FC.

After determining the number of FCs having an outbound capacity utilization value of above the predetermined threshold, one or more processors 305 may feed an optimization heuristic with at least one of the postal codes mapped to a region from the initial distribution 400 to generate one or more additional distributions of postal codes. In generating one or more additional distributions of postal codes, for example, one or more processors 305 may maintain at least one of the postal codes mapped to a region, while randomly varying the rest of the postal codes mapped to other regions in distribution 400. Then, one or more processors 305 may calculate the outbound capacity utilization values of each FC again and determine the number of FCs having an outbound utilization value that exceeds the predetermined threshold with the new distribution of postal codes. One or more processors 305 may repeat these steps and generate additional distributions of postal codes until a termination requirement is met. For example, the termination requirement may be met when the number of FCs having an outbound capacity utilization value of above the predetermined threshold exceeds a second predetermined threshold. That is, one or more processors 305 may continue feeding the optimization heuristic to generate, using the optimization heuristic, one or more additional distributions of postal codes mapped to each region until a predetermined number of FCs have an outbound capacity utilization value exceeding the predetermined threshold. Once the number of FCs having an outbound capacity utilization value of above the predetermined threshold exceeds a second predetermined threshold, the distribution 400 of priority values may constitute an optimal distribution of postal codes mapped to each region. One or more processors 305 may, then, use the optimal distribution of postal codes generated to modify an allocation of customer orders and/or SKUs among the plurality of FCs.

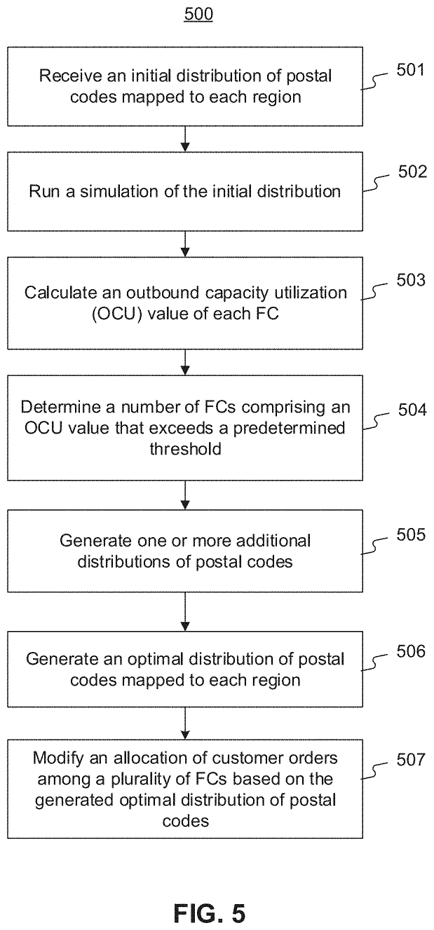

FIG. 5 is a flow chart illustrating an exemplary method 500 for outbound forecasting. This exemplary method is provided by way of example. Method 500 shown in FIG. 5 can be executed or otherwise performed by one or more combinations of various systems. Method 500 as described below may be carried out by the outbound forecasting system 301, as shown in FIG. 3, by way of example, and various elements of that system are referenced in explaining the method of FIG. 5. Each block shown in FIG. 5 represents one or more processes, methods, or subroutines in the exemplary method 500. Referring to FIG. 5, exemplary method 500 may begin at block 501.

At block 501, one or more processors 305 may receive an initial distribution of postal codes mapped to each region. The initial distribution of postal codes, such as distribution 400 in FIG. 4, may be randomly generated. After receiving the initial distribution of postal codes mapped to each region, method 500 may proceed to block 502. At block 502, one or more processors 305 may run a simulation, using a simulation model, of the initial distribution. For example, one or more processors 305 may simulate the outbound flow of products based on the initial distribution of postal codes mapped to each region. By way of example, referring back to FIG. 4, one or more processors 305 may simulate, using the simulation model, the outbound flow of products when customer orders being delivered to postal code 12589 is stowed in an FC in region R₁, when customer orders being delivered to postal code 15879 is stowed in an FC in region R₂, and when customer orders being delivered to postal code 12568 is stowed in an FC in region R₃. When customer orders are allocated to FCs in different regions as such, one or more processors 305 may determine the performance of each FC in each region.

In order to determine the performance of each FC while running a simulation of the initial distribution 400, method 500 may proceed to block 503, at which one or more processors 305 may calculate an outbound capacity utilization (OCU) value of each FC. As discussed above, the OCU value may comprise a ratio of an outbound of each FC to an outbound capacity of the FC. By way of example, the OCU value of each FC may range from about 0.01 to about 1. After calculating the OCU value of each FC based on the initial distribution of postal codes mapped to each region, method 500 may proceed to block 504. At block 504, one or more processors 305 may determine a number of FCs comprising an OCU value that exceeds a predetermined threshold. The predetermined threshold may comprise a minimum outbound of each FC.

After determining the number of FCs having an outbound capacity utilization value of above the predetermined threshold, method 500 may proceed to block 505. At block 505, one or more processors 305 may feed an optimization heuristic, such as a genetic algorithm, with at least one of the postal codes mapped to a region from the initial distribution, such as distribution 400, to generate one or more additional distributions of postal codes.

In generating one or more additional distributions of postal codes, for example, one or more processors 305 may maintain at least one of the postal codes mapped to a region, while randomly varying the rest of the postal codes mapped to other regions in distribution 400. Then, one or more processors 305 may calculate the outbound capacity utilization values of each FC again and determine the number of FCs having an outbound utilization value that exceeds the predetermined threshold with the new distribution of postal codes. One or more processors 305 may repeat these steps and generate additional distributions of postal codes until a termination requirement is met. For example, the termination requirement may be met when the number of FCs having an outbound capacity utilization value of above the predetermined threshold exceeds a second predetermined threshold. For example, the second predetermined threshold may comprise a predetermined number of FCs. That is, one or more processors 305 may continue feeding the optimization heuristic to generate one or more additional distributions of postal codes mapped to each region until a predetermined number of FCs have an outbound capacity utilization value exceeding the predetermined threshold. For example, the predetermined number of FCs may comprise a value between about 70% and 100% of the FCs in the network.

Once the number of FCs having an outbound capacity utilization value of above the predetermined threshold exceeds a second predetermined threshold, method 500 may proceed to block 506. At block 506, one or more processors 305 may generate, using the optimization heuristic, an optimal distribution of postal codes mapped to each region. For example, the optimal distribution of postal codes may comprise one of the generated distributions of postal codes, through which the number of FCs having an outbound capacity utilization value of above the predetermined threshold exceeds a second predetermined threshold. For example, the optimal distribution of postal codes mapped to each region may comprise the distribution of postal codes generated that meets the termination requirement.

After generating the optimal distribution of postal codes, method 500 may proceed to block 507. At block 507, one or more processors 305 may use the generated optimal distribution of postal codes mapped to each region to modify an allocation of customer orders among a plurality of FCs. For example, one or more processors 305 may assign customer orders to the FCs, based on the delivery addresses associated with each customer order and the generated optimal distribution of postal codes mapped to each region. By way of example, if an open purchase order has a delivery address associated with a particular postal codes that is mapped to a first region in the optimal distribution of postal codes generated, then one or more processors 305 may assign the open purchase order to the first region such that one or more products in the open purchase order may be stowed in an FC in the first region.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for outbound forecasting, the system comprising:
a memory storing instructions; and
at least one processor configured to execute the instructions to:
receive an initial distribution of postal codes mapped to each region;
run a simulation, using a simulation model, of the initial distribution, wherein running the simulation comprises simulating an allocation of customer orders based on the initial distribution of postal codes;
calculate an outbound capacity utilization value of each network of fulfillment centers (FCs) in each region;
determine a number of networks of FCs comprising an outbound capacity utilization value that exceeds a predetermined threshold;
feed a genetic algorithm with at least one of the postal codes mapped to a region from the initial distribution to generate one or more additional distributions of postal codes, until the number of networks of FCs comprising the outbound capacity utilization value that exceeds the predetermined threshold exceeds a second predetermined threshold;
generate, using the genetic algorithm, an optimal distribution of postal codes mapped to each region based on the one or more additional distributions of postal codes;
assign customer orders to a plurality of FCs based on the generated optimal distribution of postal codes;
generate one or more purchase orders to purchase a quantity of products to satisfy the customer orders assigned to the plurality of FCs based on the generated optimal distribution of postal codes; and
send instructions to a plurality of mobile devices, each mobile device associated with a respective user physically in an FC, to stow the purchased products for shipping to customers.

2. The system of claim 1, wherein the predetermined threshold comprises a minimum outbound of each network of FCs.

3. The system of claim 1, wherein the outbound capacity utilization value of each network of FCs comprises a ratio of an outbound of each network of FCs to an outbound capacity of each network of FCs.

4. (canceled)

5. The system of claim 1, wherein the initial distribution of postal codes mapped to each region is randomly generated.

6. The system of claim 1, wherein the at least one processor is further configured to execute the instructions to cache at least a portion of the genetic algorithm.

7. The system of claim 6, wherein the cached portion of the genetic algorithm comprises at least one constraint that remains substantially constant with each run of the simulation model.

8. The system of claim 1, wherein the at least one processor is further configured to execute the instructions to:
determine one or more constraints associated with at least one of the postal codes; and
apply the one or more constraints to the genetic algorithm to generate the one or more additional distributions of postal codes.

9. The system of claim 8, wherein applying the one or more constraints to the genetic algorithm comprises eliminating at least one of the one or more additional distributions of postal codes that ignore the one or more constraints.

10. The system of claim 1, wherein the genetic algorithm comprises at least one constraint, the constraint comprising at least one of customer demand at each of the FCs, maximum capacities of the FCs, compatibility with FCs, or transfer costs between FCs.

11. A computer-implemented method for outbound forecasting, the method comprising:
receiving an initial distribution of postal codes mapped to each region;
running a simulation, using a simulation model, of the initial distribution wherein running the simulation comprises simulating an allocation of customer orders based on the initial distribution of postal codes;
calculating an outbound capacity utilization value of each network of fulfillment centers (FCs) in each region;
determining a number of networks of FCs comprising an outbound capacity utilization value that exceeds a predetermined threshold;
feeding a genetic algorithm with at least one of the postal codes mapped to a region from the initial distribution to generate one or more additional distributions of postal codes, until the number of networks of FCs comprising the outbound capacity utilization value that exceeds the predetermined threshold exceeds a second predetermined threshold;
generating, using the genetic algorithm, an optimal distribution of postal codes mapped to each region based on the one or more additional distributions of postal codes;
assigning customer orders to a plurality of FCs based on the generated optimal distribution of postal codes;
generating one or more purchase orders to purchase a quantity of products to satisfy the customer orders assigned to the plurality of FCs based on the generated optimal distribution of postal codes; and
sending instructions to a plurality of mobile devices, each mobile device associated with a respective user physically in an FC, to stow the purchased products for shipping to customers.

12. The method of claim 11, wherein the predetermined threshold comprises a minimum outbound of each network of FCs.

13. The method of claim 11, wherein the outbound capacity utilization value of each network of FCs comprises a ratio of an outbound of each network of FCs to an outbound capacity of each network of FCs.

14. (canceled)

15. The method of claim 11, wherein the initial distribution of postal codes mapped to each region is randomly generated.

16. The method of claim 11, further comprising caching at least a portion of the genetic algorithm.

17. The method of claim 16, wherein the cached portion of the genetic algorithm comprises at least one constraint that remains substantially constant with each run of the simulation model.

18. The method of claim 11, further comprising:
determining one or more constraints associated with at least one of the postal codes; and
applying the one or more constraints to the genetic algorithm to generate the one or more additional distributions of postal codes.

19. The method of claim 18, wherein applying the one or more constraints to the genetic algorithm comprises eliminating at least one of the one or more additional distributions of postal codes that ignore the one or more constraints.

20. A computer-implemented system for outbound forecasting, the system comprising:
a memory storing instructions; and
at least one processor configured to execute the instructions to:
receive an initial distribution of postal codes mapped to each region, wherein the initial distribution of postal codes is randomly generated, and wherein running the simulation comprises simulating an allocation of customer orders based on the initial distribution of postal codes;
run a simulation, using a simulation model, of the initial distribution;
calculate an outbound capacity utilization value of each network of fulfillment centers (FCs);
determine a number of networks of FCs comprising an outbound capacity utilization value that exceeds a predetermined threshold;
determine one or more constraints associated with at least one of the postal codes;
feed a genetic algorithm with at least one of the postal codes mapped to a region from the initial distribution to generate one or more additional distributions of postal codes, until the number of networks of FCs comprising the outbound capacity utilization value that exceeds the predetermined threshold exceeds a second predetermined threshold, wherein:
one or more constraints are applied to the genetic algorithm to generate the one or more additional distributions of postal codes;
generate, using the genetic algorithm, an optimal distribution of postal codes mapped to each region based on the one or more additional distributions of postal codes;
assign customer orders to a plurality of FCs based on the generated optimal distribution of postal codes;
generate one or more purchase orders to purchase a quantity of products to satisfy the customer orders assigned to the plurality of FCs based on the generated optimal distribution of postal codes; and
send instructions to a plurality of mobile devices, each mobile device associated with a respective user physically in an FC, to stow the purchased products for shipping to customers.
